(19) United States
(12) Patent Application Publication
(10) Pub. No.: US 2008/0041707 A1
(43) Pub. Date: Feb. 21, 2008

(54) Sealing assembly for a moveable shaft and switch having same

(75) Inventor: Davin R. Lee, Watertown, WI (US)

Correspondence Address: Eaton Electrical, Inc.;Technology & Quality Center, RIDC Park West, 170 Industry Drive, Pittsburgh, PA, 15275-1032, US

(73) Assignee: EATON CORPORATION

(21) Appl. No.: 11/505,098

(22) Filed: Aug. 16, 2006

(51) Int. Cl. H01H 13/00

(52) U.S. Cl. 200/339

(57) ABSTRACT

A sealing assembly for a moveable shaft is provided. The sealing assembly includes a housing with a recess disposed therein. A resilient member with an inner diameter and an outer diameter is provided that is disposed within the recess. The outer diameter of the resilient member is greater than an inner diameter of the recess which provides an interference fit between the resilient member and the recess in order to compressingly engage the resilient member with the recess and hold the resilient member within the recess. An outer diameter of the moveable shaft is greater than the inner diameter of the resilient member which provides an interference fit between the moveable shaft and the resilient member in order to compressingly engage the resilient member with the moveable shaft. A switch having a sealing assembly for a moveable shaft is also provided.

### FIELD OF THE INVENTION

This invention generally relates to a sealing assembly for a moveable shaft. The invention also relates to a switch having a sealing assembly for a moveable shaft.

### BACKGROUND INFORMATION

Moveable shafts that are operable between a plurality of positions in an apparatus often require the use of an O-ring or other suitable sealing member around the moveable shaft to prevent debris or dirt from entering a portion of the apparatus that may contain, by way of example and not limitation, contacts or other mechanism for providing an electrical connection. The problem with the O-ring is that it has a relatively small cross section (i.e., circular when cut through one portion thereof) that can cause a loss of sealing if the moveable shaft is moved.

For example, the O-ring or other suitable sealing member remains stationary as the moveable shaft is moved thereby allowing debris or dirt to enter the portion of the apparatus through a gap formed between the moveable shaft and O-ring or other suitable sealing member. In other words, the inner diameter of the O-ring does not flex in one axial direction or in the opposite axial direction in order to provide an interference fit between the entire circumference of the inner diameter of the O-ring and the moveable shaft responsive to movement of the moveable shaft. As can be appreciated, this type of seal has the potential of failing in dirty or dusty environments. Other variations of sealing members for moveable shafts exist although there is still room for improvement in maintaining the interference fit between a sealing member and the moveable shaft responsive to movement of the moveable shaft.

Accordingly, there is room for improvement in a sealing assembly for a moveable shaft. There is also room for improvement in a switch having a sealing assembly for a moveable shaft.

### SUMMARY OF THE INVENTION

It is an object of the invention to provide a sealing assembly that provides an interference fit between a sealing member and a moveable shaft.

It is another object of the invention to provide a sealing assembly that maintains an interference fit between a sealing member and a moveable shaft responsive to movement of the moveable shaft.

It is another object of the invention to provide a switch that has a sealing member with an interference fit between the sealing member and a moveable shaft in the switch.

It is another object of the invention to provide a switch that has a sealing member with an interference fit between the sealing member and a moveable shaft responsive to movement of the moveable shaft.

As one aspect of the invention, a sealing assembly for a moveable shaft is provided that has an outer diameter. The sealing assembly includes a housing with a recess disposed therein. The recess has an inner diameter and an outer diameter. The housing has an outer diameter. A resilient member is provided that is disposed within the recess. The resilient member has an inner diameter and an outer diameter. The outer diameter of the moveable shaft is greater than the inner diameter of the resilient member which is structured to provide an interference fit between the moveable shaft and the resilient member in order to compressingly engage the resilient member with the moveable shaft. The outer diameter of the resilient member is greater than the inner diameter of the recess which is structured to provide an interference fit between the outer diameter of the resilient member and the inner diameter of the recess in order to compressingly engage the resilient member with the recess and hold the resilient member within the recess. The outer diameter of the recess is substantially less than the outer diameter of the housing.

As another aspect of the invention, a sealing assembly for a moveable shaft is provided. The sealing assembly includes a housing with a recess disposed therein. A resilient member is provided that is disposed within the recess. The resilient member has an aperture and an annular groove formed therein which defines a connector segment connected to a plurality of proximate nodes. The proximate nodes have a thickness and the connector segment has a thickness less than the thickness of the proximate nodes. The aperture of the resilient member is structured to have the moveable shaft pass through the aperture.

As another aspect of the invention, a switch is provided. The switch includes a housing with an opening, a cavity and a recess disposed therein. The recess has an inner diameter and an outer diameter. The housing has an outer diameter. A base is provided having contacts extending into the cavity with the base being coupled to the housing. A moveable shaft is provided having an outer diameter. The moveable shaft is operable between a plurality of positions and has a first end and a second end. The first end of the moveable shaft is disposed at the opening of the housing. The second end of the moveable shaft extends into the cavity of the housing toward the base. A resilient member is disposed within the recess with the resilient member having an inner diameter and an outer diameter. The outer diameter of the moveable shaft is greater than the inner diameter of the resilient member which is structured to provide an interference fit between the moveable shaft and the resilient member in order to compressingly engage the resilient member with the moveable shaft. The outer diameter of the resilient member is greater than the inner diameter of the recess which is structured to provide an interference fit between the outer diameter of the resilient member and the inner diameter of the recess in order to compressingly engage the resilient member with the recess and hold the resilient member within the recess. The outer diameter of the recess is substantially less than the outer diameter of the housing. The moveable shaft is structured to be activated by a user to establish an electrical connection responsive to movement of the moveable shaft.

### BRIEF DESCRIPTION OF THE DRAWINGS

A full understanding of the invention can be gained from the following description of the preferred embodiments when read in conjunction with the accompanying drawings in which:

FIG. 1 is a side cross-sectional view of a sealing assembly and switch in accordance with an embodiment of the invention:

FIG. 2 is a side cross-sectional view of the sealing assembly and switch of FIG. 1, but with the moveable shaft thereof in an actuated position;

FIG. 3 is an exploded isometric view of the switch of FIG. 1;

FIG. 4 is a side cross-sectional view of the sealing assembly and switch of FIG. 1;

FIG. 5 is a top plan view of the resilient member of FIG. 1;

FIG. 6 is a side cross-sectional view of the resilient member of FIG. 1;

FIG. 7 is a side cross-sectional view of a sealing assembly and switch in accordance with another embodiment of the invention:

FIG. 8 is a side cross-sectional view of the sealing assembly and switch of FIG. 7, but with the moveable shaft thereof in an actuated position;

FIG. 9 is an exploded isometric view of the switch of FIG. 7;

FIG. 10 is a side cross-sectional view of the sealing assembly and switch of FIG. 7;

FIG. 11 is a top plan view of the resilient member of FIG. 7; and

FIG. 12 is a side cross-sectional view of the resilient member of FIG. 7.

### DESCRIPTION OF THE PREFERRED EMBODIMENTS

For purposes of the description hereinafter, the terms “upper”, “lower”, “vertical”, “horizontal”. “top”, “bottom”, “aft”, “behind”, “forward”, “rear”, “beneath”, “below” and derivatives thereof shall relate to the structures as oriented in the drawings. However, it is to be understood that the invention may assume various alternative configurations except where expressly specified to the contrary. It is also to be understood that the specific elements illustrated in the drawings and described in the following specification are simply example embodiments of the invention. Therefore, specific dimensions, orientations and other physical characteristics related to the embodiments disclosed herein are not to be considered limiting.

As employed herein, the statement that two or more parts are “coupled”, “attached” or “connected” means that the parts are joined together either directly or joined indirectly through one or more intermediate parts.

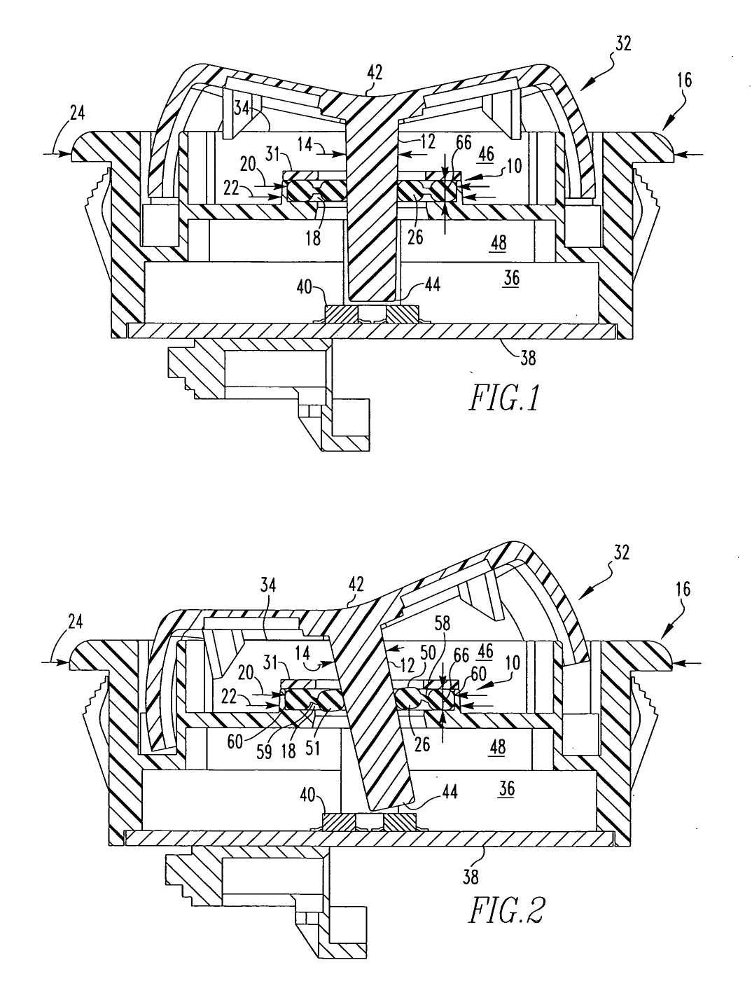

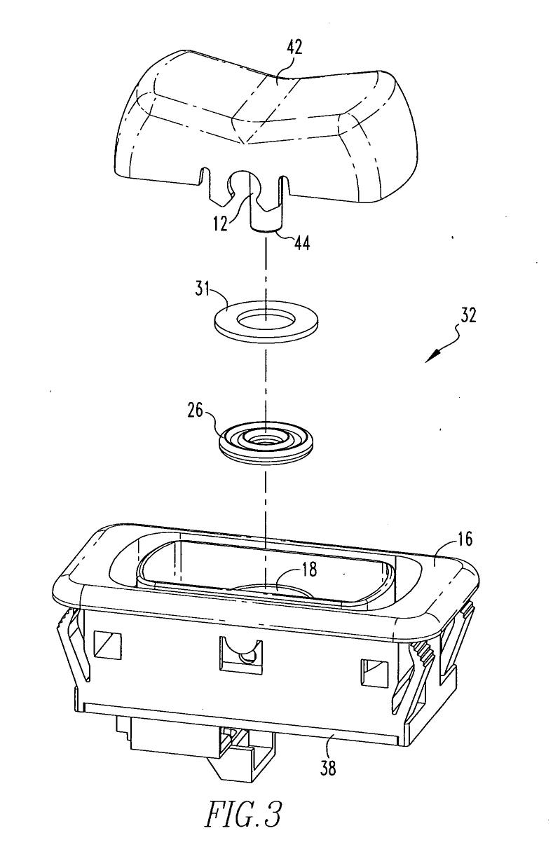

Turning to an embodiment of the invention shown in FIGS. 1-4, a sealing assembly 10 is shown. The sealing assembly 10 is for a moveable shaft 12 having an outer diameter 14. The sealing assembly 10 has a housing 16 with a recess 18 disposed therein. The recess 18 has an inner diameter 20 and an outer diameter 22. The housing 16 has an outer diameter 24.

A resilient member 26 is disposed with the recess 18. With reference to FIGS. 5-6, the resilient member 26 has an inner diameter 28 and an outer diameter 30. The resilient member 26 could be made of, by way of example and not limitation, rubber, silicone, other elastomeric materials and the like. With reference to FIGS. 1-2, the outer diameter 14 of the moveable shaft 12 is greater than the inner diameter of the resilient member 26 which compressingly engages the resilient member 26 with the moveable shaft 12. The resilient member 26 provides an interference fit between the outer diameter 14 of the moveable shaft 12 and the inner diameter 28 of the resilient member 26.

The outer diameter 30 of the resilient member 26 is greater than the inner diameter 20 of the recess 18 which provides an interference fit between the outer diameter 30 of the resilient member 26 and the inner diameter 20 of the recess 18 in order to compressingly engage the resilient member 26 with the recess 18 and hold the resilient member 26 within the recess 18. The interference fit between the recess 18 and the resilient member 26 may additionally assist in compressingly engaging the resilient member 26 with the moveable shaft 12. The outer diameter 22 of the recess 18 is substantially less than the outer diameter 24 of the housing 16. The housing 16 is structured to receive a retainment member 31 located proximate to the recess 18 and the resilient member 26 which retainment member 31 holds the resilient member 26 in place. By way of example and not limitation, retainment member 31 could be a disc, a flat washer, a keyed washer, a lock washer, a serrated washer, another suitable washer, an elastomeric member, a resilient member, a shim, a spacer or other suitable retainment mechanism or device.

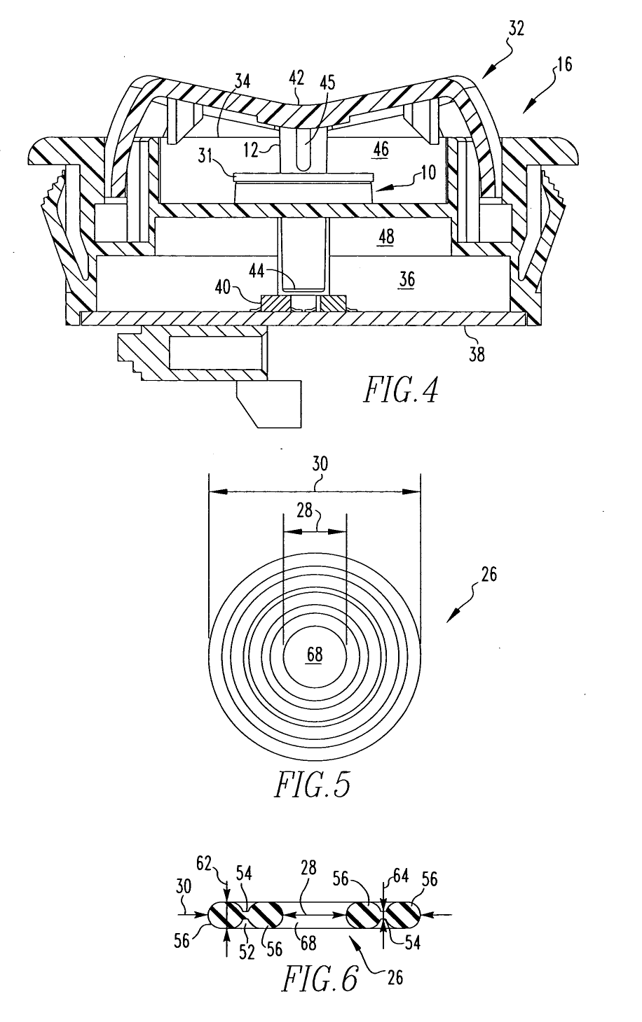

The sealing assembly 10 may be contained within a switch 32 as shown in FIGS. 1-4. The switch 32 has housing 16 which has an opening 34, a cavity 36 and the recess 18 disposed therein. The switch 32 has a base 38 having contacts 40. While the base 38 is shown as a separate element coupled to the housing 16, an integral base (not shown) is also contemplated by embodiments of the invention. In this example, the contacts 40 are a proximity sensor. The term “contacts” means any known or suitable mechanism adapted to detect the position of a moveable shaft, such as, 12, and expressly includes, without limitation, mechanical contacts, such as moveable contacts structured to be physically engaged by the second end 44 of the moveable shaft 12, as well as “proximity sensors” which are adapted to detect the position of the moveable shaft 12 without requiring contact between the moveable shaft 12 and the sensor. Proximity sensors include, for example, and without limitation, optical sensors (e.g., photo-detectors), inductive proximity sensors, hall sensors, capacitive proximity sensors, and other known or suitable non-contact position sensors generally, such as a magnetic proximity sensor structured to detect the position of a moveable shaft modified to include a magnetic element or other suitable target. The contacts 40 extend into the cavity 36. The base 38 is coupled to housing 16. The switch 32 is operable between a plurality of positions. By way of example and not limitation, the switch 32 may be activated by a user to the left (FIG. 2) or to the right (not shown) as the switch 32 is oriented in the FIGS. The moveable shaft 12 has a first end 42 and a second end 44. The first end 42 of the moveable shaft 12 is disposed at the opening 34 of the housing 16. The second end 44 of the moveable shaft 12 extends into the cavity 36 of the housing 16 toward the base 38. The moveable shaft 12 is structured to be activated by a user which establishes an electrical connection between at least some of the contacts 40 responsive to movement of the moveable shaft 12. The moveable shaft 12 may include a securement member 45 coupled thereto as shown in FIG. 4. The securement member 45 is structured to hold the retainment member 31 to the resilient member 26. The securement member 45 extends into the cavity 36 and holds the retainment member 31 in the recess 18. By way of example and not of limitation, securement member 45 could be one or more crests, projections, ridges, splines or other suitable securement structure.

The housing 16 has a first portion 46 and a second portion 48. The resilient member 26 situated within the recess 18 keeps contaminants such as, for example, debris, dirt or dust from entering the second portion 48 from the first portion 46. The second portion 48 contains the contacts 40 that are structured to establish an electrical connection responsive to movement of the moveable shaft 12 (see FIG. 2). Debris, dirt or dust may negatively impair the ability of the contacts 40 to establish an electrical connection so it is desirable to eliminate such contaminants from the second portion 48.

With reference to FIG. 6, the resilient member 26 is round or oval in shape. The corresponding recess 18 has a corresponding shape to receive the resilient member 26. The inner diameter 20 of the recess 18 provides an interference fit between the outer diameter 30 of the resilient member 26 and the inner diameter 20 of the recess 18 to compressingly engage the resilient member 26 with the recess 18 and hold the resilient member 26 within the recess 18. The moveable shaft 12 drives a first portion 50 (FIG. 2) proximate to the inner diameter 28 of the resilient member 26 to flex in one direction and drives a second portion 51 proximate to the inner diameter 28 of the resilient member 26 to flex in an opposite direction responsive to movement of the moveable shaft 12. In other words, the first portion 50 of the resilient member 26 flexes in one axial direction and the second portion 51 of the resilient member 26 flexes in an opposite axial direction in order to maintain an interference fit between the entire circumference of the inner diameter 28 of the resilient member 26 and the outer diameter 12 of the moveable shaft 12 responsive to movement of the moveable shaft 12. This keeps contaminants such as, for example, debris, dirt or dust from entering the second portion 48 from the first portion 46 during actuation of the switch 32 thereby solving a technical problem associated with known prior art O-ring sealing members. Resilient member 26 is structured to maintain engagement with the moveable shaft 12 when a user activates the moveable shaft 12. The resilient member 26 has an annular groove 52 (FIG. 6) formed therein which defines a connector segment 54 connected to a plurality of proximate nodes 56. As shown in FIG. 2, the connector segment 54 also has a first portion 58 that flexes in one direction and a second portion 59 that flexes in an opposite direction like the first portion 50 and the second portion 51 responsive to movement of the moveable shaft 12 whereas a portion 60 proximate to the outer diameter 30 of the resilient member 26 does not appreciably flex responsive to movement of the moveable shaft 12.

The nodes 56 have a thickness 62 and the connector segment 54 has a thickness 64 less than the thickness 62 of the proximate nodes 56. The recess 18 has a height 66 generally equal to the thickness 62 of the proximate nodes 56 with the nodes 56 seating snug within the recess 18. An aperture 68 passing through the resilient member 26 has an hourglass like appearance in cross-section. The moveable shaft 12 passes through the aperture 68 of the resilient member 26.

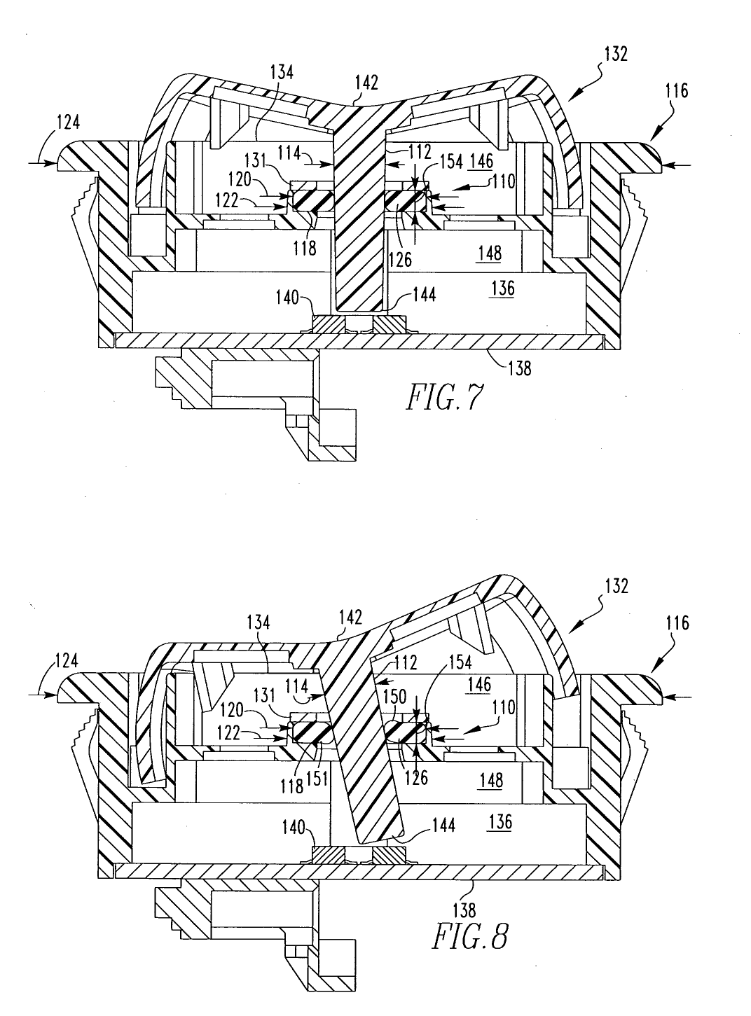

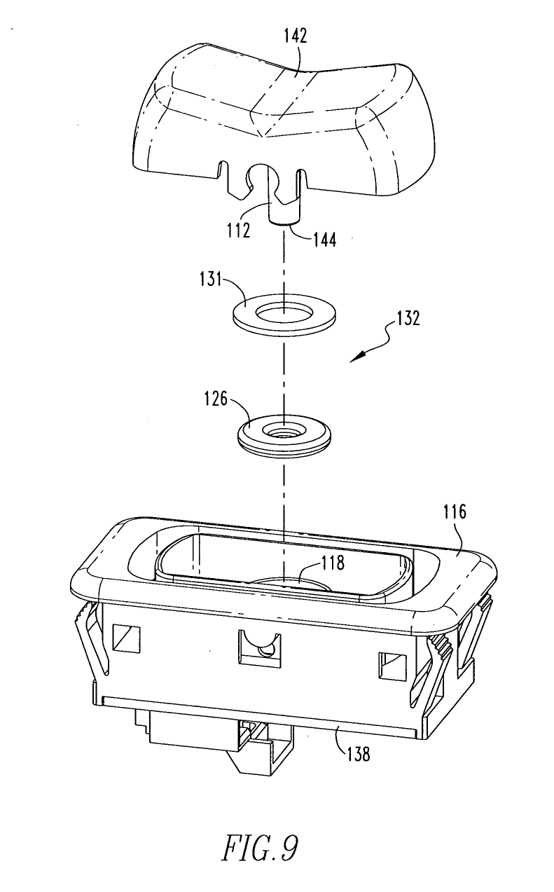

Turning to another embodiment of the invention shown in FIGS. 7-10, a sealing assembly 110 is shown. The sealing assembly 110 is for a moveable shaft 112 having an outer diameter 114. The sealing assembly 110 has a housing 116 with a recess 118 disposed therein. The recess 118 has an inner diameter 120 and an outer diameter 122. The housing 116 has an outer diameter 124.

A resilient member 126 is disposed with the recess 118. With reference to FIGS. 11-12, the resilient member 126 has an inner diameter 128 and an outer diameter 130. The resilient member 126 could be made of, by way of example and not limitation, rubber, silicone, other elastomeric materials and the like. With reference to FIGS. 7-8, the outer diameter 114 of the moveable shaft 112 is greater than the inner diameter 128 of the resilient member 126 which compressingly engages the resilient member 126 with the moveable shaft 112. The resilient member 126 provides an interference fit between the outer diameter 114 of the moveable shaft 112 and the inner diameter 128 of the resilient member 126.

The outer diameter 130 of the resilient member 126 is greater than the inner diameter 120 of the recess 118 which provides an interference fit between the outer diameter 130 of the resilient member 126 and the inner diameter 120 of the recess 118 in order to compressingly engage the resilient member 126 with the recess 118 and hold the resilient member 126 within the recess 118. The interference fit between the recess 118 and the resilient member 126 may additionally assist in compressingly engaging the resilient member 126 with the moveable shaft 112. The outer diameter 122 of the recess 118 is substantially less than the outer diameter 124 of the housing 116. The housing 116 is structured to receive a retainment member 131 located proximate to the recess 118 and the resilient member 126 which retainment member 131 holds the resilient member 126 in place. By way of example and not limitation, retainment member 131 could be a disc, a flat washer, a keyed washer, a lock washer, a serrated washer, another suitable washer, an elastomeric member, a resilient member, a shim, a spacer or other suitable retainment mechanism or device.

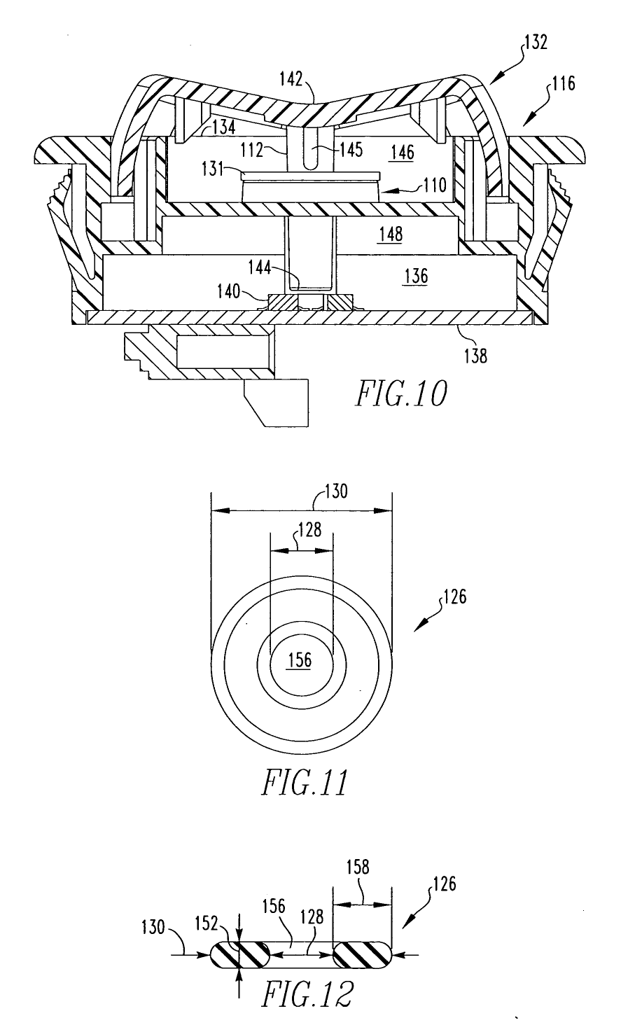

The sealing assembly 110 may be contained within a switch 132 as shown in FIGS. 7-10. The switch 132 has housing 116 which has an opening 134, a cavity 136 and the recess 118 disposed therein. The switch 132 has a base 138 having contacts 140. While the base 138 is shown as a separate element coupled to the housing 116, an integral base (not shown) is also contemplated by embodiments of the invention. In this example, the contacts 140 are a proximity sensor. The term “contacts” has the meaning provided before to describe the embodiment of FIGS. 1-6 of the invention. The contacts 140 extend into the cavity 136. The base 138 is coupled to housing 116. The switch 132 is operable between a plurality of positions. By way of example and not limitation, the switch 132 may be activated by a user to the left (FIG. 8) or to the right (not shown) as the switch 132 is oriented in the FIGS. The moveable shaft 112 has a first end 142 and a second end 144. The first end 142 of the moveable shaft 112 is disposed at the opening 134 of the housing 116. The second end 144 of the moveable shaft 112 extends into the cavity 136 of the housing 116 toward the base 138. The moveable shaft 112 is structured to be activated by a user which establishes an electrical connection between at least some of the contacts 140 responsive to movement of the moveable shaft 112. The moveable shaft 112 may include a securement member 145 coupled thereto (FIG. 10). The securement member 145 is structured to hold the retainment member 131 to the resilient member 126. The securement member 145 extends into the cavity 136 and holds the retainment member 131 in the recess 118. By way of example and not of limitation, securement member 145 could be one or more crests, projections, ridges, splines or other suitable securement structure.

The housing 116 has a first portion 146 and a second portion 148. The resilient member 126 situated within the recess 118 keeps contaminants such as, for example, debris, dirt or dust from entering the second portion 148 from the first portion 146. The second portion 148 contains contacts 140 that are structured to establish an electrical connection responsive to movement of the moveable shaft 112 (FIG. 8). Debris, dirt or dust may negatively impair the ability of the contacts 140 to establish an electrical connection so it is desirable to eliminate such contaminants from the second portion 148.

With reference to FIG. 12, the resilient member 126 is oval in shape. The corresponding recess 118 has a corresponding shape to receive the resilient member 126. The inner diameter 120 of the recess 118 provides an interference fit between the outer diameter 130 of the resilient member 126 and the inner diameter 120 of the recess 118 to compressingly engage the resilient member 126 with the recess 118 and hold the resilient member 126 within the recess 118. The moveable shaft 112 drives a first portion 150 (FIG. 8) proximate to the inner diameter 128 of the resilient member 126 to flex in one direction and drives a second portion 151 proximate to the inner diameter 128 of the resilient member 126 to flex in an opposite direction responsive to movement of the moveable shaft 112. In other words, the first portion 150 of the resilient member 126 flexes in one axial direction and the second portion 151 of the resilient member 126 flexes in an opposite axial direction in order to maintain an interference fit between the entire circumference of the inner diameter 128 of the resilient member 126 and the outer diameter 114 of the moveable shaft 112 responsive to movement of the moveable shaft 112 to keep contaminants such as, for example, debris, dirt or dust from entering the second portion 148 from the first portion 146 during actuation of the switch 132 thereby solving a technical problem associated with known prior art O-ring sealing members. Resilient member 126 is structured to maintain engagement with the moveable shaft 112 when a user activates the moveable shaft 112. The resilient member 126 has a generally uniform thickness 152 (FIG. 12) and the recess 118 has a height 154 generally equal to the thickness 152 of the resilient member 126 with the resilient member 126 seating generally flush within the recess 118. An aperture 156 passing through the resilient member 126 has an hourglass like appearance in cross-section. The moveable shaft 112 passes through the aperture 156 of the resilient member 126. The resilient member 126 is generally toroidal in shape with a width portion 158 being greater than the thickness 152. This enables the portions 150, 151 to flex in opposite directions as has been described in connection with FIG. 8.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the invention which is to be given the full breadth of the claims appended hereto and any and all equivalents thereto.

What is claimed is:

1. A sealing assembly for a moveable shaft having an outer diameter, the sealing assembly comprising:
a housing with a recess disposed therein, the recess having an inner diameter and an outer diameter, the housing having an outer diameter; and
a resilient member disposed within the recess, the resilient member having an inner diameter and an outer diameter,
wherein the outer diameter of the moveable shaft is greater than the inner diameter of the resilient member which is structured to provide an interference fit between the moveable shaft and the resilient member in order to compressingly engage the resilient member with the moveable shaft,
wherein the outer diameter of the resilient member is greater than the inner diameter of the recess which is structured to provide an interference fit between the outer diameter of the resilient member and the inner diameter of the recess in order to compressingly engage the resilient member with the recess and hold the resilient member within the recess, and
wherein the outer diameter of the recess is substantially less than the outer diameter of the housing.

2. The sealing assembly of claim 1, wherein the housing has a first portion and a second portion, and
wherein the resilient member is structured to keep contaminants from entering the second portion from the first portion.

3. The sealing assembly of claim 2, wherein the second portion of the housing is structured to contain contacts therein for establishing an electrical connection responsive to movement of the moveable shaft.

4. The sealing assembly of claim 3, wherein the moveable shaft is structured to be activated by a user to establish the electrical connection responsive to the movement of the moveable shaft.

5. The sealing assembly of claim 1, wherein the moveable shaft is structured to drive a first portion proximate to the inner diameter of the resilient member to flex in one direction, and
wherein the moveable shaft is structured to drive a second portion proximate to the inner diameter of the resilient member to flex in an opposite direction.

6. The sealing assembly of claim 5, wherein the resilient member has a generally uniform thickness,
wherein the recess has a height generally equal to the thickness of the resilient member,
wherein the resilient member is structured to seat generally flush within the recess, and
wherein the resilient member has a width greater than the thickness of the resilient member.

7. The sealing assembly of claim 1, wherein the resilient member has an annular groove formed therein which defines a connector segment connected to a plurality of proximate nodes,
wherein the proximate nodes have a thickness, and
wherein the connector segment has a thickness less than the thickness of the proximate nodes.

8. The sealing assembly of claim 1, wherein the resilient member is structured to maintain engagement with the moveable shaft when a user activates the moveable shaft.

9. The sealing assembly of claim 1, wherein the housing is structured to receive a retainment member located proximate to the recess and the resilient member.

10. The sealing assembly of claim 9, wherein the moveable shaft includes a securement member coupled thereto, the securement member being structured to hold the retainment member to the resilient member.

11. A sealing assembly for a moveable shaft, the sealing assembly comprising:
a housing with a recess disposed therein; and
a resilient member disposed within the recess, the resilient member having an aperture and an annular groove formed therein which defines a connector segment connected to a plurality of proximate nodes, the proximate nodes having a thickness, the connector segment having a thickness less than the thickness of the proximate nodes, and
wherein the aperture of the resilient member is structured to have the moveable shaft pass through the aperture.

12. The sealing assembly of claim 11, wherein the moveable shaft has an outer diameter,
wherein the resilient member has an inner diameter and an outer diameter,
wherein the recess has an inner diameter,
wherein the outer diameter of the moveable shaft is greater than the inner diameter of the resilient member which is structured to provide an interference fit between the moveable shaft and the resilient member in order to compressingly engage the resilient member with the moveable shaft, and
wherein the outer diameter of the resilient member is greater than the inner diameter of the recess which is structured to provide an interference fit between the resilient member and the recess in order to compressingly engage the resilient member with the recess and hold the resilient member within the recess.

13. The sealing assembly of claim 11, wherein the housing is structured to receive a washer located proximate to the recess and the resilient member.

14. The sealing assembly of claim 13, wherein the moveable shaft includes one or more projections coupled thereto in order to hold the washer to the resilient member.

15. A switch comprising:
a housing having an opening, a cavity and a recess disposed therein, the recess having an inner diameter and an outer diameter, the housing having an outer diameter;
a base having contacts extending into the cavity, the base being coupled to the housing;
a moveable shaft having an outer diameter, the moveable shaft being operable between a plurality of positions and having a first end and a second end, the first end of the moveable shaft being disposed at the opening of the housing, the second end of the moveable shaft extending into the cavity of the housing toward the base; and
a resilient member disposed within the recess, the resilient member having an inner diameter and an outer diameter,
wherein the outer diameter of the moveable shaft is greater than the inner diameter of the resilient member which is structured to provide an interference fit between the moveable shaft and the resilient member in order to compressingly engage the resilient member with the moveable shaft,
wherein the outer diameter of the resilient member is greater than the inner diameter of the recess which is structured to provide an interference fit between the outer diameter of the resilient member and the inner diameter of the recess in order to compressingly engage the resilient member with the recess and hold the resilient member within the recess,
wherein the outer diameter of the recess is substantially less than the outer diameter of the housing, and
wherein the moveable shaft is structured to be activated by a user to establish an electrical connection responsive to movement of the moveable shaft.

16. The switch of claim 15, wherein the moveable shaft is structured to drive a first portion proximate to the inner diameter of the resilient member to flex in one direction, and
wherein the moveable shaft is structured to drive a second portion proximate to the inner diameter of the resilient member to flex in an opposite direction.

17. The switch of claim 16, wherein the resilient member has a generally uniform thickness,
wherein the recess has a height generally equal to the thickness of the resilient member,
wherein the resilient member is structured to seat generally flush within the recess, and
wherein the resilient member has a width greater than the thickness of the resilient member.

18. The switch of claim 15, wherein the resilient member has an annular groove formed therein which defines a connector segment connected to a plurality of proximate nodes,
wherein the proximate nodes have a thickness, and
wherein the connector segment has a thickness less than the thickness of the proximate nodes.

19. The switch of claim 15, wherein the resilient member is structured to maintain engagement with the moveable shaft when a user activates the moveable shaft.

20. The switch of claim 15, wherein the housing receives a washer located proximate to the recess and the resilient member, the washer being structured to hold the resilient member in the recess, and
wherein the moveable shaft includes one or more projections coupled thereto that extend into a first portion of the housing and hold the washer to the resilient member.
